(19) United States
(12) Patent Application Publication
(10) Pub. No.: US 2020/0257942 A1
(43) Pub. Date: Aug. 13, 2020

(54) METHOD AND DEVICE FOR DETERMINING A DRIVING BEHAVIOR

(71) Applicant: Robert Bosch GmbH, Stuttgart (DE)

(72) Inventors: Henar Martin Rodriguez, Stuttgart (DE); Peter Bakucz, Klosterlechfeld (DE)

(73) Assignee: Robert Bosch GmbH, Stuttgart (DE)

(21) Appl. No.: 16/639,218

(22) PCT Filed: Aug. 9, 2018
(86) PCT No.: PCT/EP2018/071700

§ 371 Date: Feb. 14, 2020

(30) Foreign Application Priority Data
Aug. 16, 2017 (DE) 102017214241.3

(51) Int. Cl. G06K 9/62; B60W 40/09; B60W 40/105

(52) U.S. Cl. CPC G06K 9/6277; B60W 40/105; B60W 40/09

(57) ABSTRACT

A method for ascertaining a driving behavior of a driver of a vehicle includes: acquiring a three-dimensional signal of an acceleration sensor, the three-dimensional signal including a respective acceleration value in each of independent spatial directions; calculating a characteristic variable of the three-dimensional signal; and outputting the driving behavior based on the characteristic variable, via an output device, the characteristic variable being a measure of an aggressiveness of a driving behavior, and the characteristic variable including a fractal dimension of an embedding of the three-dimensional signal and/or a Kolmogorov entropy of the three-dimensional signal.

### CROSS-REFERENCE TO RELATED APPLICATIONS

The present application is the national stage of International Pat. App. No. PCT/EP2018/071700 filed Aug. 9, 2018, and claims priority under 35 U.S.C. § 119 to DE 10 2017 214 241.3, filed in the Federal Republic of Germany on Aug. 16, 2017, the content of each of which are incorporated herein by reference in their entireties.

### FIELD OF THE INVENTION

The present invention relates to a method and to a device for ascertaining a driving behavior of a driver of a vehicle.

### BACKGROUND

From the existing art, efforts are known to ascertain the driving behavior of a driver of a vehicle on public roadways. The driving behavior can be characterized in particular by a degree of aggressiveness of driving maneuvers, taking other vehicles into consideration, and/or the number and degree of instances of driving with excessive speed. For this purpose, a signal of an acceleration sensor is evaluated. Aggressiveness is understood in particular as a rapid and/or abrupt change in the speed and/or direction of travel of the vehicle.

The ascertaining of driving behavior of individual drivers is of interest in particular for insurance companies. In this way, insurance rates can be expanded to include a personal feature, so that for example aggressive drivers must pay a higher premium than cautious drivers.

For example, U.S. Pat. App. Pub. No. 2014/0191858 describes a system for characterizing a driving behavior of a driver based on various driving processes.

U.S. Pat. App. Pub. No. 2015/0081404 discloses a comparison of a driving behavior of a driver with normal driving behavior. Finally, WO 2015/121639 discloses wavelet transformations and comparisons with templates stored in a database, in order to recognize various driving processes that permit inference of the driving behavior.

However, it is difficult to ascertain in general an intensity of a driving process because various characteristics of the signal of an acceleration sensor can be very different in different acceleration sensors. For example, amplitudes that indicate the same acceleration can have different magnitudes in different acceleration sensors. In addition, different surfaces on which a vehicle is moving can result in different amplitudes in the signal of the acceleration sensor.

Many systems from the existing art are based on the identification of driving processes through the use of sensor information from onboard diagnostic systems of the vehicle. This solution results in significant data queries, and can impair the safety of the vehicle, so that complicated developments are required.

If a fusion of data is carried out of different sensor signals, such as signals from acceleration sensors and GPS systems, then a high degree of performance of the control device that carries out the fusion is required because a significant computing outlay is necessary. This results in high piece costs of corresponding devices for recognizing the driving behavior.

Solutions based on a calibration of a gravitation sensor work satisfactorily only if the calibration is carried out on a flat surface. Moreover, additional analyses, some of which are complicated, must be carried out in order to determine whether the vehicle is driving up or down a slope, or is driving in reverse.

In principle, in a three-dimensional signal of an acceleration sensor, a plurality of components are superposed. These are in particular an acceleration/braking portion, a curved travel portion, and a noise portion. The acceleration/braking portion describes signals that result from driver-initiated acceleration processes and braking processes of the vehicle in order to change the speed of the vehicle. The curved travel portion describes signals that result from a driver-initiated curved path of the vehicle. All of these components have a similarly broad spectrum so that filtering using known spectral methods is not possible.

### SUMMARY OF THE INVENTION

Through a method and device according to the present invention, a driving behavior can be ascertained independent of a vehicle type. The same driving processes result in different signals in different vehicles. Therefore, it is not possible to specifically analyze each individual signal.

Through a method and device according to the present invention, it is not necessary to carry out such explicit analyses to reliably ascertain the driving behavior. In particular, the ascertaining of the driving behavior is independent of properties of the surface on which the vehicle is situated. The ascertaining of the driving behavior is also independent of whether the vehicle is moving forward or in reverse, or uphill or downhill. The ascertaining of the driving behavior can also be carried out in real time.

A method according to the present invention for ascertaining a driving behavior of a driver includes the following steps: first, there takes place an acquiring of a three-dimensional signal of an acceleration sensor, the three-dimensional signal including an acceleration value in three independent spatial directions. The acceleration sensor is thus used to acquire accelerations along these three spatial directions. However, it is not known which orientations these spatial directions have. Through the method according to the present invention, however, such an orientation is also not necessary in order to ascertain the driving behavior. As a further step, there takes place an ascertaining of a characteristic variable of the three-dimensional signal. The characteristic variable is a measure of a degree of aggressiveness of a driving behavior of the driver; in particular, the aggressiveness increases with the characteristic variable. The characteristic variable includes a fractal dimension of an embedding of the three-dimensional signal and/or a Kolmogorov entropy of the three-dimensional signal. Based on these characteristic variables, the driving behavior can be determined easily and at low expense. In particular, precise examinations of the three-dimensional signal are not necessary. As a final step, the driving behavior is outputted based on the characteristic variable, via an output device. In this way, the driving behavior can be provided to further systems. Because it is made possible in particular to determine the driving behavior in real time, the driving behavior can also be transmitted in real time to a central instance. In this way, up-to-date data about the driving behavior are always available.

A device according to the present invention for ascertaining a driving behavior of a driver includes at least one acceleration sensor, an output device, and a control device. The at least one acceleration sensor is designed to acquire acceleration values in three independent spatial directions. The acceleration sensor can thus output a three-dimensional signal, each dimension of the signal indicating an acceleration in one of the spatial directions. The output device is used to output the driving behavior. In particular, the output device is provided with a wireless transmitter in order to enable the ascertained driving behavior to be transmitted wirelessly to a receiver. The receiver can be in particular a higher-order control unit. The control device is designed to acquire the three-dimensional signal of the acceleration sensor. Moreover, the control device is designed to calculate a characteristic variable of the three-dimensional signal. The characteristic variable is a measure of an aggressiveness of the driving behavior. In particular, it is provided that the aggressiveness increases as the characteristic variable increases. The characteristic variable includes a fractal dimension of an embedding of the three-dimensional signal and/or a Kolmogorov entropy of the three-dimensional signal. The characteristic variable can be ascertained easily and at low expense. At the same time, the characteristic variable ensures that a driving behavior can be recognized reliably and with certainty.

The terms “fractal dimension,” “embedding,” and “Kolmogorov entropy” are to be understood in particular as they are defined in mathematics. The term “three-dimensional signal” is to be understood as meaning that the signal includes values from three dimensions.

Preferably, various probability distributions for the Kolgomorov entropy of the three-dimensional signal are predefined, and a predefined driving behavior is assigned to each probability distribution. Thus, based on a comparison between the number of actual occurrences of particular Kolmogorov entropies and the probable number of the occurrence of said Kolmogorov entropies, it can be determined which driving behavior is occurring. Thus, regarded statistically, in the case of moderate driving behavior, medium Kolmogorov entropies will occur most frequently. If this is also the case in reality, then it can be assumed that this is based on moderate driving behavior. If, in contrast, in reality there occur more small Kolmogorov entropies than medium ones, then normal driving behavior is to be assumed.

Preferably, it is provided that increasing values of the Kolmogorov entropy of the three-dimensional signal indicate an increasing aggressiveness of the driving behavior. Thus, larger Kolmogorov entropies indicate a high potential aggression of the driving behavior, while smaller Kolmogorov entropies indicate a low potential aggression of the driving behavior. In this way, a driving behavior can be determined easily and at low expense.

Preferably, the embedding takes place through a nonlinear transformation of the three-dimensional signal of the acceleration sensor. The nonlinearity is approximated by linear assumptions. Through the nonlinear transformation, an acceleration/braking portion is separated from a curved travel portion of the three-dimensional signal. In this way, a separate examination of the acceleration/braking portion and of the curved travel portion is enabled. A driving behavior can therefore be ascertained separately based on changes in speed and/or curved paths.

The fractal dimension for the acceleration/braking portion and for the curved travel portion are in particular ascertained separately. In this way, the signal can be examined in detailed fashion, the higher of the two ascertained fractal dimensions, as driving behavior, being used as the characteristic variable. Thus, it can occur that the driver for example has an inherent tendency towards aggressive curved travel behavior, but does not accelerate and/or brake the vehicle aggressively. Nonetheless, the driving behavior is to be rated as aggressive overall.

Advantageously, intervals of fractal dimensions are predefined, a different driving behavior being assigned to each interval. If a fractal dimension is calculated as characteristic variable, then the driving behavior can be ascertained by checking in which interval the fractal dimension falls. Because a corresponding driving behavior is already assigned to each interval, in this way the ascertaining can take place easily and at low expense.

An increasing fractal dimension indicates in particular an increasing aggressiveness of the driving behavior. In this way, from the fractal dimension alone it can be recognized how aggressively a driver is driving. The fractal dimension thus represents a certain and reliable measure for the driving behavior. Ascertaining of the driving behavior is therefore possible easily and at low expense.

Preferably, the characteristic variable is ascertained from the unfiltered and/or unprocessed three-dimensional signal of the acceleration sensor. In this way, a complicated filtering and/or processing of the three-dimensional signal is not necessary. This saves, in particular, computing expense in the ascertaining of the driving behavior.

According to a further aspect of the present invention, a computer program product (e.g., a data memory) has stored therein instructions that make a programmable processor capable of carrying out the steps of a method as described above. The computer program product can be realized as a CD, DVD, Blu-Ray disk, flash memory, hard drive, RAM/ROM, cache, etc.

In the following, example embodiments of the present invention are described in detail with reference to the accompanying drawings.

### BRIEF DESCRIPTION OF THE DRAWINGS

FIG. 1 is a schematic flowchart of a method according to an example embodiment of the present invention.

FIG. 2 is a schematic view of a device according to an example embodiment of the present invention.

FIG. 3 is a schematic diagram of the course of a determination of a Kolmogorov entropy, according to an example embodiment of the present invention.

FIG. 4 is a schematic diagram of an assignment of different driving behaviors to different values of the Kolgomorov entropy, according to an example embodiment of the present invention.

FIG. 5 is a schematic diagram of a course of an embedding through nonlinear transformation, according to an example embodiment of the present invention.

FIG. 6 is a schematic diagram of a first three-dimensional signal of an acceleration sensor after the embedding, according to an example embodiment of the present invention.

FIG. 7 is a schematic diagram of a second three-dimensional signal of an acceleration sensor after the embedding, according to an example embodiment of the present invention.

FIG. 8 is a schematic diagram of a third three-dimensional signal of an acceleration sensor after the embedding, according to an example embodiment of the present invention.

### DETAILED DESCRIPTION

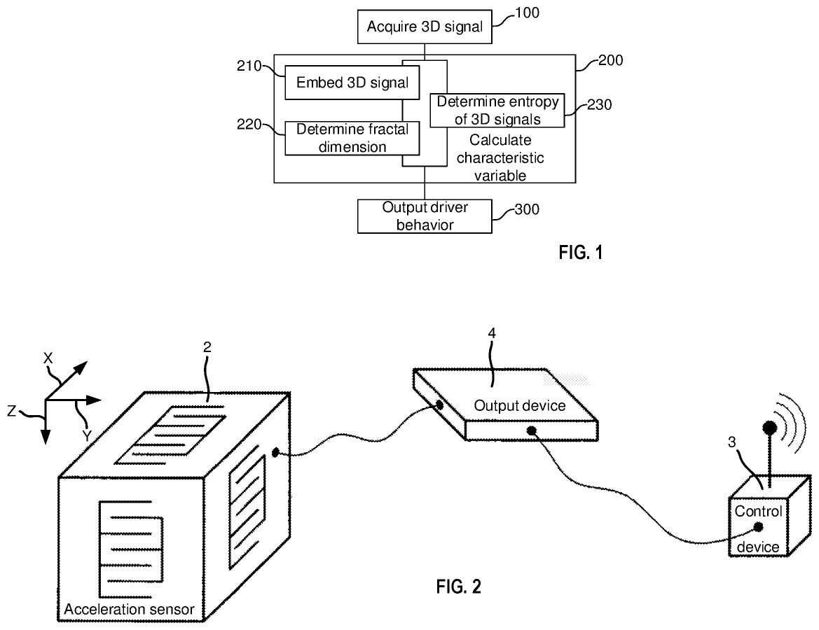

FIG. 1 schematically shows a sequence plan of a method according to an example embodiment of the present invention. FIG. 2 shows a device 1 according to an example embodiment of the present invention. It is provided that device 1 can be attached to a vehicle in order to ascertain a driving behavior of the driver of the vehicle based on the method.

Device 1 includes an acceleration sensor 2, an output device 3, and a control device 4. Control device 4 is connected to acceleration sensor 2 and to output device 3 for signal transmission. In addition, control device 4 is preferably set up to carry out the method shown in FIG. 1.

The method includes the following steps: first, there is an acquisition 100 of a three-dimensional signal of acceleration sensor 1. For this purpose, acceleration sensor 1 can acquire an acceleration in three independent spatial directions x, y, and z. Thus, the three-dimensional signal indicates an acceleration value for each spatial direction. However, no information can be derived from the three-dimensional signal about concrete accelerations of the vehicle, because it is not known which of the spatial directions have which orientations in the vehicle. Because a calibration of acceleration sensor 2 inside the vehicle is complicated and often imprecise, the present invention dispenses with the requirement of such a calibration.

There subsequently follows a calculation 200 of a characteristic variable of the three-dimensional signal. The calculation 200 can in particular be done in two different ways. In both cases, it is advantageous that a driving behavior can be ascertained without the orientations of the spatial axes x, y, z having to be known.

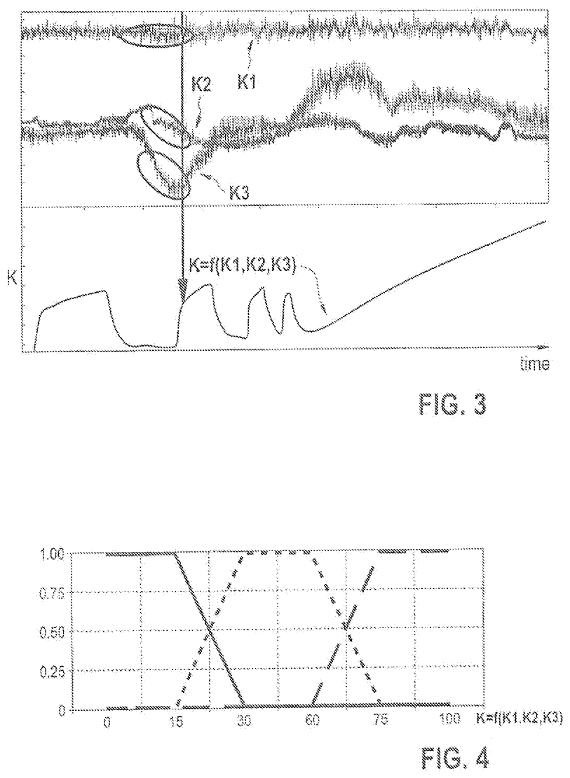

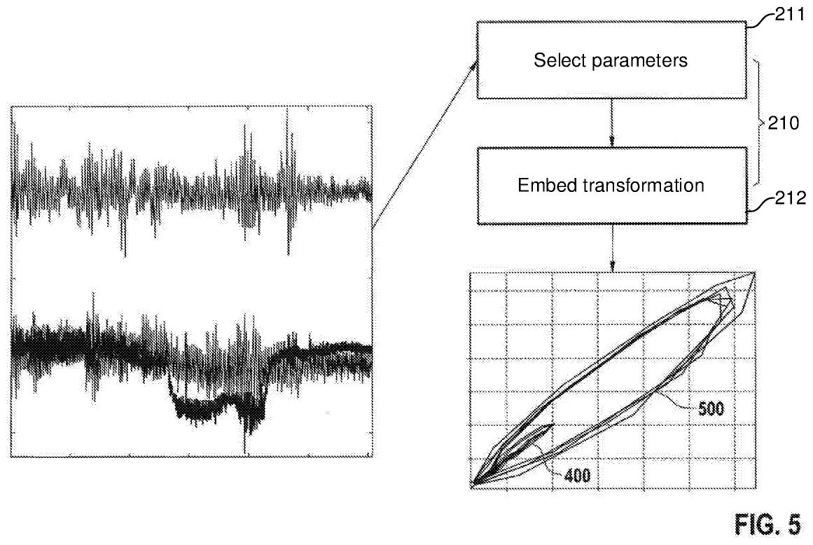

One possibility for carrying out calculation 200 of the characteristic variable includes an embedding 210 of the three-dimensional signal and a subsequent determination 220 of a fractal dimension of the signal. This possibility is described below with reference to FIGS. 5-8. Alternatively, a determination 230 of a Kolmogorov entropy of the three-dimensional signals can be carried out. This is described below with reference to FIGS. 3 and 4. Thus, the characteristic variable is either the fractal dimension or the Kolmogorov entropy. A combination of these is also possible.

The calculated characteristic variable is in particular a measure of the driving behavior. Thus, there takes place a step of outputting 300 of the driving behavior via an output device 3, based on the characteristic variable. Output device 3 is advantageously a transmit station, so that the driving behavior can be sent to a receiver. In this way, the driving behavior of different drivers can be stored by a central unit and further processed. A local storing of the ascertained driving behavior in the respective devices 1 is also possible.

The three-dimensional signal of acceleration sensor 2 includes in particular an acceleration/braking portion, a curved travel portion, and a noise portion. All these portions are superposed to form the three dimensional signal. If the characteristic variable is calculated through the embedding 210 and determination 200 of the fractal dimension, the signal is partitioned, at least with regard to the acceleration/braking portion and the curved travel portion. In contrast, in the determination of the Kolmogorov entropy such a partitioning is not required.

In the following, based on FIGS. 3 and 4, it is explained how the driving behavior can be ascertained using the Kolmogorov entropy as characteristic variable. For this purpose, the Kolmogorov entropy is determined in three dimensions (1, 2, 3) K=(K1, K2, K3), using correlation integrals, as follows:

$$K = f ( K 1 , K 2 , K 3 ) = {\sum }_{i = l}^{3} {lim}_{m \to ∝} {lim}_{r \to 0} {K}_{i}^{m} ( r ) .$$

### Here,

$${K}_{i}^{m} ( r ) = \frac{1}{k Δ t} ln \frac{{P}^{m} ( r )}{{P}^{m + k} ( r )} ;$$

l=1, 2, 3 represents the three dimensions of the signal of acceleration sensor 2; k is a constant, in particular an adequately small integer; m is the dimension of the embedding; and P^{m}(r) is the spectrum of the signal of acceleration sensor 2, stored in particular in a buffer.

FIG. 3 shows as an example how the characteristic variable K of the signal is ascertained. This characteristic value is a measure of the driving behavior. Here, high values of K mean that the driving behavior is to be evaluated as aggressive.

In order to avoid fluctuations, the above-described equation

$${K}_{i}^{m} ( r ) = \frac{1}{k Δ t} ln \frac{{P}^{m} ( r )}{{P}^{m + k} ( r )}$$

is averaged over four different starting values of the buffer, while at the same time the functional dependence of the characteristic K(1,2,3) on m is approximated by the following function, using the method of least squares:

$${K}_{i = 1 , 2 , 3}^{m} ( r ) = {K}_{2} + \frac{v}{4 L Δ t} {\sum }_{i = 1}^{L} \frac{1}{l } ln ( \frac{m + 2 l}{m} )$$

FIG. 4 schematically shows some probability distributions of the Kolmogorov entropy K of the three-dimensional signal. Here, a driving behavior is assigned to each probability distribution. Thus, the solid line in FIG. 4 for example indicates a normal driving behavior, the dotted line indicates a moderate driving behavior, and the dashed line indicates an aggressive driving behavior. As described above, increasing values of the Kolmogorov entropy K indicate an increasingly aggressive driving behavior. Thus, FIG. 4 shows that, given aggressive driving behavior, high values of the Kolmogorov entropy K are most probable, while in the case of moderate driving behavior medium values of the Kolmogorov entropy K are most probable. In the case of normal driving behavior, small values of the Kolmogorov entropy K are most probable.

Through the categorization shown in FIG. 4, a driving behavior of the driver can be ascertained easily and at low expense from the three-dimensional acceleration signal. For this purpose, only the frequency distribution of the occurring values of the Kolmogorov entropy K is to be ascertained. Based on the probability distributions, this number can then be unambiguously assigned to a driving behavior.

FIGS. 5-8 show an alternative possibility for calculating the characteristic variable. The idea behind this is that the acceleration portion/braking portion can be approximated optimally by a manifold having low dimension. Through projection onto the stated manifold, there takes place a separation of the acceleration/braking portion from the curved travel portion.

For example, the three-dimensional signal can be as follows: {sₙ} (n=1, . . . , N), where N is the number of measurement points.

This three-dimensional signal can be unfolded into a multidimensional effective phase space, the following delay coordinates being used: sₙ=s_{n(m-1)t, . . . , s}_{ₙ}, where m=1, . . . , M, and where M is a size of the attractor and t is a delay.

Regarded mathematically, the three-dimensional signal is a scalar measurement of a deterministic dynamic system. Even if a deterministic dynamic system is not assumed here, serial functional dependencies are nonetheless present in the three-dimensional signal that have the result that the delay vectors sₙ fill the available m-dimensional space in an inhomogenous manner.

In order to carry out the embedding 210, first there is a selection 211 of three parameters:
the length of the embedded window;
the dimension d of the local manifold onto which projection is to take place; and
the diameter dₙ of the neighborhood used for the linear approximation.

Using these parameters, an embedded transformation 212 into the phase space is carried out. The embedding window can be used to select components, and the neighborhood is used to define a length scaling in the phase space. These parameters thus represent a description for expressing the differences between the acceleration/braking portion and the curved travel portion. Here, the acceleration/braking portion has a much larger amplitude than does the curved travel portion, and the spectrum of the acceleration/braking portion appears shorter than the spectrum of the curved travel portion.

The ascertaining of the driving behavior of the driver takes place based on the characteristic variable of the fractal dimension. The larger the fractal dimension is, the greater the aggressiveness of the driving behavior. For this purpose, T is used as the topological dimension, FD as the fractal dimension, and H as the Hurst exponent. For the embedding, FD>2, because there are two spatial dimensions, and an additional dimension is to be seen in the image density of the spectrum of the acceleration/braking portion as well as of the spectrum of the curved travel portion. The parameters H and FD can be estimated based on the following equation: E[Δ²f]=c[Δ^{H}d]², where E is an expectation operator, Δf is an intensity operator, Δd is a spatial distance, and c is a scaling constant.

If, in this equation, the substitutions E=3−FD and κ=E(|Δf|) are made, there then results E(|Δf|)=κ Δd^{H}.

Application of the logarithmic function to both sides of this equation yields log E(|Δf|)=log κ+H log Δd.

The Hurst exponent H can be ascertained through linear regression using the method of least squares in order to estimate a gray level difference relative to k in a doubled logarithmic scale. Here, k varies from 1 to a maximum value s, and the following holds:

$$GD ( k ) = \frac{{\sum }_{i = 1}^{N} {\sum }_{j = 1}^{N - k - 1} \vert I ( i , j ) - I ( i , j + k \vert + {\sum }_{i = 1}^{N - k - 1} {\sum }_{j = 1}^{N} \vert I ( i , j ) - I ( i + k , j \vert}{2 N ( N - k - 1 )}$$

The fractal dimension FD can be obtained from the equation FD=3−H. A small value of the fractal dimension FD implies a large Hurst exponent, representing fine textures, while a large fractal dimension FD implies a small Hurst exponent H, representing coarse textures.

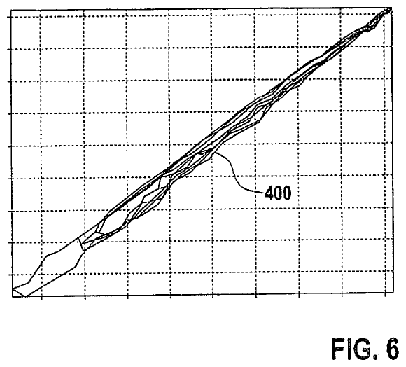

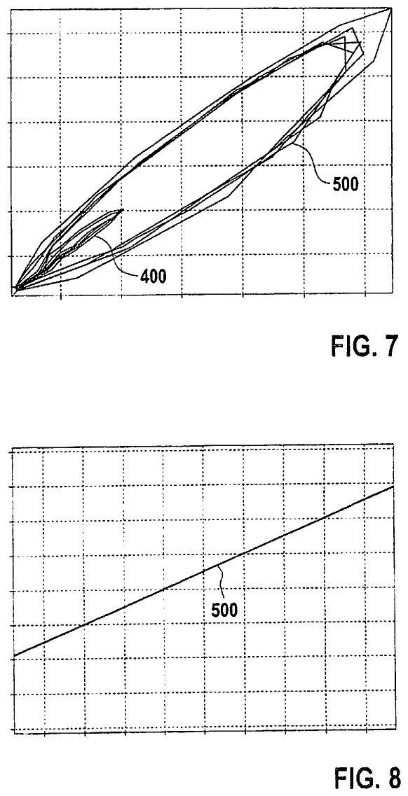

FIGS. 6-8 show individual examples of a three-dimensional signal transformed into the phase space. In FIG. 6, only an acceleration dynamic 400 is shown, while FIG. 7 shows both an acceleration dynamic 400 and a curved travel dynamic 500. Finally, FIG. 8 shows a pure curved travel dynamic 500. Acceleration dynamic 400 thus represents the acceleration/braking portion, while curved travel dynamic 500 represents the curved travel portion.

In order to ascertain the driving behavior, intervals can be defined that are each assigned to a driving behavior. Thus, for example, it can be defined that a driving behavior is to be regarded as normal given a fractal dimension of less than 2.1. Between 2.1 and 2.4, the driving behavior is to be regarded as moderate. However, if the fractal dimension exceeds 2.4, then the driving behavior is to be rated as aggressive.

In FIG. 6, the fractal dimension of the acceleration dynamic 400 is greater than 2.4, so that an aggressive behavior is ascertained. In FIG. 7, the fractal dimension of the curved travel dynamic 500 is indeed less than 2.1, which would permit inference of a normal driving behavior, but the fractal dimension for the acceleration dynamic 400 continues to be greater than 2.4. Therefore, in FIG. 7 as well, the driving behavior is to be regarded as aggressive, because here the larger value of the characteristic variable, i.e., of the fractal dimension, is always decisive.

Finally, FIG. 8 shows that only curved travel dynamic 500 is present. Here, the fractal dimension is less than 2.1. Thus, the driving behavior is to be rated as normal.

As described above, through the present invention inferences about the driving behavior can be made without having to filter the three-dimensional signal of the acceleration sensor. Calibration of the acceleration sensor is also not required. Thus, the driving behavior can be ascertained easily and with a low outlay.

1-10. (canceled)

11. A method comprising:
acquiring a three-dimensional signal of an acceleration sensor, the three-dimensional signal including a respective acceleration value in each of a plurality of spatial directions;
calculating a characteristic variable of the three-dimensional signal, wherein the characteristic variable:
includes a fractal dimension of an embedding of the three-dimensional signal and/or a Kolmogorov entropy of the three-dimensional signal; and
is a measure of an aggressiveness of a driving behavior of a driver of a vehicle;
determining the driving behavior based on the characteristic value; and
outputting the determined driving behavior.

12. The method of claim 11, wherein:
the characteristic variable includes the Kolmogorov entropy of the three-dimensional signal;
different probability distributions are predefined for the Kolmogorov entropy of the three-dimensional signal; and
a respective predefined driving behavior is assigned to each probability distribution.

13. The method of claim 11, wherein the characteristic variable includes the Kolmogorov entropy of the three-dimensional signal, and the Kolmogorov entropy is such that the greater is a value of the Kolmogorov entropy of the three-dimensional signal, the greater the aggressiveness that is indicated by the value of the Kolmogorov entropy.

14. The method of claim 11, wherein:
the characteristic variable includes the fractal dimension of an embedding of the three-dimensional signal; and
the embedding takes place through a nonlinear transformation of the three-dimensional signal of the acceleration sensor that separates an acceleration/braking portion of the three-dimensional signal from a curved travel portion of the three-dimensional signal.

15. The method of claim 14, further comprising:
ascertaining a first fractal dimension for the acceleration/braking portion and a second fractal dimension for the curved travel portion, wherein a higher of the first and second fractal dimensions is used as the characteristic variable.

16. The method of claim 11, wherein:
the characteristic variable includes the fractal dimension of an embedding of the three-dimensional signal; and
a plurality of intervals of fractal dimensions are predefined, with a different driving behavior being assigned to each of the intervals.

17. The method of claim 11, wherein the characteristic variable includes the fractal dimension of an embedding of the three-dimensional signal, and the fractal dimension is such that the greater is a value of the fractal dimension, the greater the aggressiveness that is indicated by the value of the fractal dimension.

18. The method of claim 11, wherein the characteristic variable is ascertained from an unfiltered and/or unprocessed three-dimensional signal of the acceleration sensor.

19. A non-transitory computer-readable medium on which are stored instructions that are executable by a processor and that, when executed by the processor, cause the processor to perform a method, the method comprising:
acquiring a three-dimensional signal of an acceleration sensor, the three-dimensional signal including a respective acceleration value in each of a plurality of spatial directions;
calculating a characteristic variable of the three-dimensional signal, wherein the characteristic variable:
includes a fractal dimension of an embedding of the three-dimensional signal and/or a Kolmogorov entropy of the three-dimensional signal; and
is a measure of an aggressiveness of a driving behavior of a driver of a vehicle;
determining the driving behavior based on the characteristic value; and
outputting the determined driving behavior

20. A device comprising:
an acceleration sensor configured to acquire acceleration values in each of three spatial directions;
an output; and
a control device that is connected to the acceleration sensor and to the output;
wherein the control device is configured to:
acquire a three-dimensional signal of the acceleration sensor, the three-dimensional signal including a respective acceleration value in each of the three spatial directions;
calculate a characteristic variable of the three-dimensional signal, wherein the characteristic variable:
includes a fractal dimension of an embedding of the three-dimensional signal and/or a Kolmogorov entropy of the three-dimensional signal; and
is a measure of an aggressiveness of a driving behavior of a driver of a vehicle;
determine the driving behavior based on the characteristic value; and
output the determined driving behavior via the output.
